(19) United States
(12) Patent Application Publication
(10) Pub. No.: US 2021/0309827 A1
(43) Pub. Date: Oct. 7, 2021

(54) SANITARY ARTICLE

(71) Applicant: Duravit Aktiengesellschaft, Hornberg (DE)

(72) Inventor: Thomas STAMMEL, Hornberg (DE)

(21) Appl. No.: 17/218,816

(22) Filed: Mar. 31, 2021

(30) Foreign Application Priority Data
Apr. 6, 2020 (EP) 20 168 180.6

(51) Int. Cl. C08K 3/015; C08K 7/28; C08K 3/26; C08K 3/105; C08K 3/22; B05D 1/02; B05D 1/18; C08L 67/00; C08K 3/36; B29C 39/18; B29C 39/38; B29C 33/62

(52) U.S. Cl. CPC C08K 3/015; B05D 2508/00; C08K 3/26; C08K 3/105; C08K 3/22; B05D 1/02; B05D 1/18; C08L 67/00; C08K 3/36; B29C 39/18; B29C 39/38; B29C 33/62; C08K 2003/265; C08K 2003/2241; C08K 7/28

(57) ABSTRACT

A sanitary article, which has a support body and an outer coating which is applied to the support body at least in certain portions and forms the outer side of the sanitary article, the support body being of a first composite material of a filled polymeric binder matrix containing at least one filler in the form of hollow glass beads and the outer coating being of a second composite material of a polymeric binder matrix, which is filled with at least one filler and does not contain any hollow glass beads.

### CROSS-REFERENCE TO RELATED APPLICATIONS

The present application claims priority of EP 20 168 180.6, filed Apr. 6, 2020, the priority of this application is hereby claimed, and this application is incorporated herein by reference.

### BACKGROUND OF THE INVENTION

The invention relates to a sanitary article.

A variety of forms of sanitary articles are known; to be mentioned merely by way of example are bathtubs, shower bases and trays, wash basins or WCs. In addition to the possibility of producing a sanitary article from a ceramic, it is also known to produce sanitary articles from a composite material of a filled polymeric binder matrix. This technique is applied in particular in the field of bathtubs and shower bases or shower trays. Such a composite material, which is sometimes also referred to as “solid surface”, consists of a polymeric binder, a hardening agent and also organic and/or inorganic additives, which are used for the respective desired visual and haptic properties.

Predominantly used as binders are polyester resins (UP resins) and polyester resins modified with acrylic monomers, it also being possible to use pure acrylic resins.

Methyl ethyl ketone peroxide (MEKP) is usually used for the polymerization, i.e. the crosslinking of the binder matrix.

To adjust or vary the visual and haptic properties, various organic/inorganic additives are added. By way of example, fillers are added, e.g. aluminum trihydrate (ATH), i.e. a flame retardant, or quartz, dolomite, glass, hollow glass beads, polymerized plastic chips, etc., the fillers generally being added in powdered form or finely ground. In terms of the colors, in the sanitary sector predominantly the inorganic pigment titanium dioxide (TiO₂) is added in the form of a powder or dissolved in a low-viscosity resin solution or paste, but other inorganic-based or organic-based pigments can also be used, depending on the desired color.

There are a wide variety of uses of such a composite material or such a “solid surface” product. On the one hand, articles produced in this way are distinguished by their matt appearance and warm or gentle haptics. Since the starting material is fluid, it is possible to produce relatively complex geometries, which is different in comparison with the production of sanitary products from deep-drawn acrylic sheets. The use of suitable fillers used for flame retardancy or non-combustible fillers makes it possible to classify the sanitary article produced as “flame resistant” or “non-combustible”. Finally, the color penetration of the composite material through the entire product cross section has the effect that fine scratches are not visible.

Hollow glass beads are frequently added as fillers in order to reduce the weight of the product, the reduction depending on the fill level, i.e. the quantity of hollow glass beads added. It is also possible to reduce costs by adding the hollow glass beads, since the hollow glass beads replace other, more expensive fillers. A wide variety of products having geometries which are of various types and are also complex can thus be produced from such a composite material containing hollow glass beads, but at the same time with a reduced weight of the product and at reduced costs.

The use of such a composite material filled with hollow glass beads is also possible in the sanitary sector. There, however, the problem exists that a sanitary article cast by means of a mold sometimes has to be reworked on the surface after the hardening, this usually being done by grinding. This can lead to the situation in which the hollow glass beads bound in the binder matrix generate a microporosity on the surface when they are ground open, as it were, during the mechanical reworking. This microporosity can lead to the situation in which dirt can accumulate in the pores, this possibly leading to an increased cleaning outlay.

### SUMMARY OF THE INVENTION

The invention is therefore based on the problem of specifying a sanitary article which is improved in contrast to this.

To solve this problem, according to the invention a sanitary article is provided, which has a support body and an outer coating which is applied to said support body at least in certain portions and forms the outer side of the sanitary article, the support body consisting of a first composite material of a filled polymeric binder matrix containing at least one filler in the form of hollow glass beads and the outer coating consisting of a second composite material of a polymeric binder matrix which is filled with at least one filler and does not contain any hollow glass beads.

The sanitary article according to the invention is distinguished in that it on the one hand exhibits the advantages of a composite material from which the support body is formed and which is filled with hollow glass beads, but on the other hand does not exhibit the disadvantages resulting from being filled with the hollow glass beads in terms of mechanical reworking. According to the invention, the sanitary article consists of the actual support body, which defines the shape and also the mechanical properties. This support body is formed from a first composite material, consisting of a filled polymeric binder matrix in which at least one filler in the form of hollow glass beads is introduced. That is to say that the weight of the support body is correspondingly reduced on account of the hollow-glass-bead filling, and that said support body can also be produced cost-effectively. According to the invention, an outer coating is applied to this support body, that is to say that the one or the plurality of support-body surfaces which form visible surfaces on the finished sanitary article are covered with the outer coating. This outer coating, which is very thin in comparison with the thickness of the support body, is composed of a second composite material, likewise consisting of a polymeric binder matrix, which is filled with at least one filler but does not contain any hollow glass beads. This outer coating defines the surface or outer side of the sanitary article.

Therefore, there is then the possibility of correspondingly treating, i.e. reworking and for example grinding, the support body on the surface after said support body has been produced, with the result that a very smooth surface can be obtained, on which a corresponding microporosity may well also be provided on account of the grinding of the hollow glass beads. This pore structure is, however, completely closed by applying the outer coating. The outer coating, for its part, does not absolutely have to be reworked, since as explained it is extremely thin, and in any case is applied to a support-body surface which has already been reworked. Since this outer coating or the second composite material does not contain any hollow glass beads, no problems resulting from the presence of such hollow glass beads arise on the finished sanitary article.

That is to say that the sanitary article according to the invention on the one hand exhibits the advantages of a first composite material filled with hollow glass beads, but on the other hand also exhibits a closed surface which does not have any microporosity by virtue of the outer coating. This surface is very easy to clean and does not tend toward an accumulation of dirt on the surface, since precisely no microporosity is provided. In addition, the prevailing haptic and visual properties which are offered by such a polymer-based composite material are retained on the sanitary article according to the invention, since, as explained, the second composite material is also one which is composed of a filled polymeric binder matrix and exhibits the corresponding haptic and visual properties.

According to an expedient development of the invention, provision can be made that the constituent parts of the first composite material and the constituent parts of the second composite material are the same except for the hollow glass beads. That is to say that ultimately, both composite materials consist of identical constituent parts or components, except that the first composite material contains hollow glass beads as filler, while said hollow glass beads are missing in the second composite material. This has an advantageous effect on the production of the sanitary article, since both starting masses from which the support body on the one hand and the outer coating on the other hand are produced can be produced from the same substances.

As an alternative to this, there is however of course also the possibility that the constituent parts of the first composite material and the constituent parts of the second composite material differ at least to some extent besides the hollow glass beads. These alternatives accordingly provide different mixes for the two composite materials. This can be expedient when, for example, the first composite material requires specific fillers, which the outer coating does not necessarily have to contain, for the purpose of adjusting certain mechanical properties.

The second composite material, which as described comprises at least one filler, contains as such a filler at least one flame retardant, in particular aluminum trihydrate (ATH). This ensures that the second composite material is also correspondingly flame resistant, which of course also applies for the first composite material, which likewise contains such a flame retardant, in particular ATH, as additional filler to the hollow glass beads.

It is also expedient if the second composite material contains at least one color additive, in particular an organic pigment or an inorganic pigment. In this way, the second composite material is also correspondingly colored, preferably of course like the first composite material, with the result that a complete color penetration is provided over the entire cross section of the sanitary article. Such an inorganic pigment is preferably titanium dioxide, which correspondingly colors white the outer coating, that is to say the second composite material, as is usually customary for sanitary articles.

In a specified configuration of the invention, the second composite material can contain (in % by weight of the hardened composite material):

Polymeric binder: 44.0-65.0

Flame retardant: 35.0-55.0

Color additive: 1.0-5.0

These are the three minimum components of the second composite material. The sum of the percents by weight thereof is always 100% by weight if no additional constituent parts, such as additional fillers and the like, are included.

The first composite material may have a different nature. The first composite material may thus be an already known composite material based on a polymeric binder, as is already used to produce sanitary articles. Such a first composite material contains (in % by weight of the hardened composite material):

Polymeric binder: 34.0-49.0

Flame retardant+quartz: 47.0-62.0

Hollow glass beads: 1.0-5.1

Color additive: 2.4-2.8

It is also the case here of course that the sum of the respective constituent parts is 100% by weight when only these four are provided. If yet a further filler or the like is present, the constituent parts of the substances mentioned vary correspondingly within the intervals selected, the sum of course also always being 100% by weight in that case.

As an alternative to the above-described first composite material, in which a flame retardant and quartz are provided as filler in addition to the hollow glass beads, it is also conceivable to introduce a metal carbonate, in particular calcium carbonate, as filler in addition to the hollow glass beads. This metal carbonate can replace the quartz and possibly also the flame retardant in the form of ATH, and possibly also the color additive if it is not required.

Such a first composite material thus contains, in a further configuration of the invention (in % by weight of the hardened composite material):

Polymeric binder: 90.0-50.0

Metal carbonate: 45.0-70.0

Hollow glass beads: 0.5-9.5

It is also the case here that the sum of the constituent parts used is always 100% by weight, which is thus also a minimum composition here, the constituent part quantities varying correspondingly within the intervals specified when an additional filler or a color pigment is added.

The first composite material, which contains the metal carbonate, can also contain as filler at least one flame retardant, in particular aluminum trihydrate (ATH), to a maximum of 21% by weight. That is to say that, in addition to the metal carbonate or the calcium carbonate and the hollow glass spheres, the flame retardant or ATH is also added.

A color additive, in particular an organic pigment or an inorganic pigment, can be added to a maximum of 5.0% by weight in the first composite material containing the metal carbonate, here titanium dioxide preferably being used again as inorganic pigment.

In the preceding text, the first and the second composite material were specified in terms of their constituent parts which are fundamental, as it were, but to some extent different. In addition to the constituent parts which have already been described above, it is, however, also possible to add further additives.

There is thus the possibility that the first and/or second composite material also contains quartz as filler, the first composite material containing quartz to a maximum of 10.1% by weight and the second composite material containing quartz to a maximum of 5.7% by weight.

As an alternative or in addition to this, provision can be made that the first and/or second composite material also contains dolomite as filler, the first and the second composite material each containing dolomite to a maximum of 7.3% by weight.

Finally, provision can be made that the first and/or the second composite material also contains one or more fillers selected from zircon, muscovite, garnet, melanite and feldspar, each to a maximum of 3.8% by weight. That is to say that the first or the second composite material contains a maximum of 3.8% by weight of one or more of the fillers mentioned in total.

It is apparent that there is therefore possible variation within the specific compositions of the first and second composite materials, with the result that correspondingly selecting the constituent parts makes it possible to react to corresponding demands or properties which are correspondingly to be adjusted.

As described, the outer coating is a relatively thin coating; the thickness thereof should be between 0.1-2.0 mm, in particular between 0.2-1.5 mm. Such a small thickness can readily be obtained. This is because the outer coating is preferably sprayed on or painted on, since the second composite material for application is a fluid, i.e. sprayable. This spraying-on makes it possible to ensure that a very uniform and very thin outer coating is applied. A dip coating is also possible.

The overall thickness of carrier layer and outer layer should be between 8.0-26.0 mm, that is to say that the thickness of the carrier layer is clearly a multiple of the thickness of the outer coating.

As described already in the introduction, the article itself is preferably a bathtub, but can likewise also be a shower base, a shower tray, a wash basin, a washstand or a WC.

In addition to the sanitary article itself, the invention also relates to a method for producing a sanitary article of the type described above. Said method is distinguished in a first alternative for the method in that a fluid outer coating of a polymeric binder, which is filled with at least one filler but does not contain any hollow glass beads, is applied at least in certain portions to a support body of a first composite material of a filled binder matrix containing at least one filler in the form of hollow glass beads, said polymeric binder then hardening to form a second composite material. It is thus the case here that, in a first step, the support body is produced, which is correspondingly hardened and then, in a second step, is covered with the fluid material which forms the outer coating, i.e. the fluid second composite material, preferably by being sprayed on.

After application of the outer coating, it is hardened to form a hard, second composite material.

Specifically, such a method is distinguished by the following steps:

casting a polymeric casting composition of a filled polymeric binder containing at least one filler in the form of hollow glass beads into a mold and hardening the casting composition to form the support body,

thermally and/or mechanically aftertreating the support body which has been removed from the mold,

applying a further polymeric, fluid mass of a polymeric binder, which is filled with at least one filler but does not contain any hollow glass beads, in order to form the outer coating,

performing thermal aftertreatment in order to harden the outer coating and possibly mechanically aftertreating the outer coating.

According to the invention, accordingly, first the support body is cast by casting a polymeric casting composition from the first composite material, as was defined previously in different compositions, into a corresponding casting mold. The casting composition hardens in the mold to form the first composite material or the support body.

In the next step, after removing the support body from the mold, a thermal aftertreatment in the form of tempering is performed in order to reduce any stresses in the support body. It is possible that a mechanical aftertreatment for surface processing, in particular by grinding, follows this in order to configure the surface in a correspondingly fine manner. Both the thermal and the mechanical aftertreatment can be performed, but it is also conceivable to perform only one thereof depending on requirements.

Then, in the next step, the outer coating composition, that is to say a polymeric, fluid and thus sprayable mass of a polymeric binder, which is filled with at least one filler but now does not contain any hollow glass beads, is applied. This sprayable mass, which is adjusted such that it is correspondingly sprayable by way of a sufficiently high content of polymeric binder, usually a resin, can be applied in a very uniform and thin manner, with the result that a very homogeneous outer coating can be obtained. Following the spraying-on operation is a thermal aftertreatment for hardening the outer coating. The possibility optionally exists of also reworking the outer coating mechanically in as fine a manner as possible, this mechanical aftertreatment primarily serving to provide the outer coating with a matt finish.

As described, the outer coating is applied by means of a fluid mass, this preferably taking place by being sprayed on. As an alternative, it is also conceivable to apply the mass by dipping.

In addition to the method described above, the invention also relates in a second alternative to a further method for producing a sanitary article of the type described above. Said method is distinguished in that a fluid mass of a polymeric binder, which is filled with at least one filler but does not contain any hollow glass beads, is introduced into a mold for the purpose of coating the mold surfaces, which mass at least sets to form an outer coating, after which a further polymeric casting composition, which contains a filler in the form of hollow glass beads, is introduced into the mold such that the outer coating is backfilled, after which the mass and the casting composition harden to form two composite materials.

In this configuration of the method, the actual casting mold, in which the support body is ultimately produced, is filled with the fluid mass, which forms the outer coating, already before the introduction of the casting composition, which forms the support body, that is to say that the mold surfaces are covered with this fluid mass. The fluid mass at least sets, that is to say it transitions into a sufficiently solid state, but does not have to harden through completely. Said fluid mass merely has to be stable enough that, in the next step, the casting composition, which forms the support body and contains the hollow glass beads, can be introduced into the mold in such a way that said casting composition backfills the outer coating composition. Subsequently, the hardening of the two masses is brought about by corresponding temperature control, after which the finished article is removed from the mold.

In a further specification of this method, said method is distinguished by the following steps:

spraying the fluid mass of a polymeric binder, which is filled with at least one filler but does not contain any hollow glass beads, onto the mold surfaces,

thermally treating the coating in such a way that the coating sets to form an outer coating,

casting the further polymeric casting composition, which contains a filler in the form of hollow glass beads, into the mold such that the outer coating is backfilled,

hardening the mass and the casting composition,

thermally aftertreating the sanitary article and possibly mechanically aftertreating the outer coating.

Three tables relating to possible compositions of the first and second composite materials are specified below, said tables in each case referring to the % by weight fractions of the respective constituent part in the hardened product, i.e. when the composite material has hardened.

Table I specifies the composition of a first composite material which can be identical to the second composite material, which is specified in Table III, in terms of the composition and/or the constituent parts used, since the central minimum constituent parts, which are included necessarily, as it were, are the same and differ only in terms of the respective quantity.

Table II specifies a composition for a first composite material that can also be referred to as “filled resin”, and which contains at least one metal carbonate, in this respect calcium carbonate, as filler in addition to the hollow glass beads.

Finally, Table Ill specifies a composition for the second composite material, which forms the outer coating.

TABLE I
First composite material, first alternatives

| | First composite material |
|---|---|
| Component | % by weight |
| Binder (polyester resin) | 34.60-48.70 |
| Fillers (ATH, glass, quartz) | 47.50-61.80 |
| of which hollow glass beads | 1.20-5.10* |
| Hardening agent (MEKP) | 0-0.1 |
| Color additives (pastes/powder) | 2.40-2.75 |
| Other additives | 0-0.1 |
| (e.g. cobalt reaction accelerator) | |

TABLE II
First composite material, second alternative (filled resin)

| | First composite material |
|---|---|
| Component | % by weight |
| Binder (polyester resin) | 19.5-48.3 |
| Filler 1: Calcium carbonate | 45-70 |
| Filler 2: Hollow glass beads | 0.5-9.5 |
| (d50: 3 μm < x < 15 μm) | |
| Filler 3: ATH | 0-21 |
| (d50: 3 μm < x < 150 μm) | |
| Filler 4: Quartz | 0-10.1 |
| (d50: 3 μm < x < 250 μm) | |
| Filler 5: Dolomite | 0-7.3 |
| (d50: 3 μm < x < 200 μm) | |
| Filler 6: other silicates, e.g. zircon, | 0-3.8 |
| muscovite, garnet, melanite, feldspar | |
| Hardening agent (e.g. MEKP) | 0-0.1 |
| Color additives (pastes/powder) | 0-5.0 |
| Other additives | 0-0.1 |
| (e.g. cobalt reaction accelerator) | |

TABLE III
Second composite material

| | Second composite material |
|---|---|
| | Hardened end product |
| Component | % by weight |
| Binder (polyester resin) | 44.5-64.3 |
| Filler 1: ATH | 35-55 |
| Filler 2: Quartz | 0-5.7 |
| (d50: 3 μm < x < 250 μm) | |
| Filler 3: Dolomite | 0-7.3 |
| (d50: 3 μm < x < 200 μm) | |
| Filler 4: other silicate groups | 0-3.8 |
| Hardening agent (MEKP) | 0-0.1 |
| Color additives (pastes/powder) | 1.0- 5.0 |
| Other additives | 0-0.1 |
| (e.g. cobalt reaction accelerator) | |

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows a basic illustration of a sanitary article according to the invention in a partial view according to a first embodiment,

FIG. 2 shows a basic illustration of a sanitary article according to the invention of a second embodiment in a partial view,

FIG. 3 shows a flow diagram for elucidating the method according to the invention of a first embodiment, and

FIG. 4 shows a flow diagram for elucidating the method according to the invention of a second embodiment.

### DETAILED DESCRIPTION OF THE INVENTION

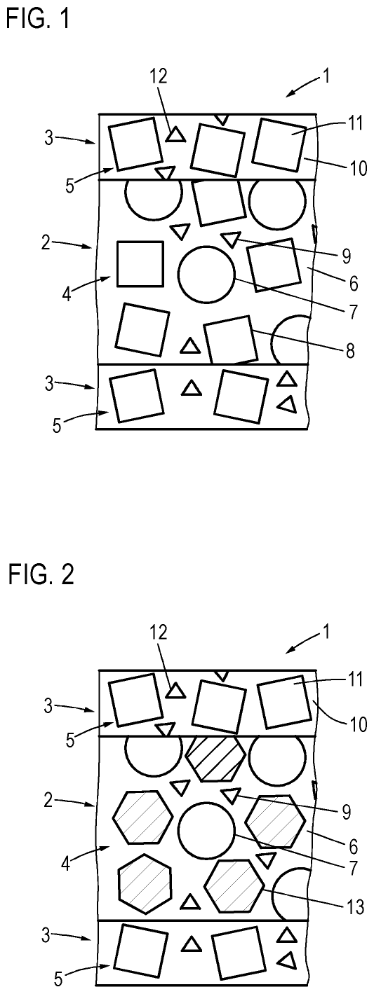

FIG. 1 shows a basic illustration of a sanitary article 1 according to the invention, which is for example a bathtub, only a detail being shown here. Shown in the basic illustration is a support body 2 which is provided on both sides with an outer coating 3. The support body 2 consists of a first composite material 4, while the two outer coatings consist of a second composite material 5.

The first composite material 4 consists of a filled polymer binder matrix 6, preferably a polyester resin. Said first composite material contains hollow glass beads 7, which serve to reduce the weight, as filler. Depending on the quantity of hollow glass beads 7 added, the weight can be reduced by up to approx. 15%.

A flame retardant 8, here in the form of aluminum trihydrate (ATH), can also be included as further filler. In addition, in the example shown, provision can be made albeit optionally for a color pigment 9, here for example TiO₂, to be included, that is to say that this is used to color the support body 2.

It is also the case that the outer coatings 5 consist of a polymeric binder matrix 10, which is in turn a polyester resin. The binder matrix 10 also contains a flame retardant 11 here, in turn aluminum trihydrate. Furthermore also included here are color pigments 12, also here in turn TiO₂.

It is clearly the case here that the first composite material 4 and the second composite material 5 as far as possible contain identical constituent parts, but in a different quantity. In the example shown, the composite materials 4, 5 differ merely in that the first composite material 4 contains the hollow glass beads 7, while the second composite material 5 does not contain said hollow glass beads.

The layer thickness of the respective outer coating 5 is in the range of from 0.1-2.0 mm, preferably from 0.2-1.5 mm, while the thickness of the support body 2 is a multiple of that. The overall thickness of the carrier layer 2 and outer layer(s) 5 should be between 8.0-26.0 mm.

As described, there is the possibility of dispensing with color pigments 9 in the first composite material 4, thus not to color it throughout. This is possible and leads to a further reduction in costs, after which the outer coating 5 contains corresponding color pigments 12, as explained.

Furthermore, there is additionally the possibility of adding further fillers, which may replace the flame retardant 8, i.e. the aluminum trihydrate, which is relatively cost-intensive, such as for example quartz, dolomite or the like.

FIG. 2 shows a further basic illustration of a sanitary article 1 according to the invention, for example in turn a detail of a bathtub. The basic structure corresponds to that as described in relation to FIG. 1, that is to say it is also the case here that a support body 2 and also outer coatings 3 on both sides are provided, the support body 2 consisting of a first composite material 4 and the outer coatings 3 consisting of a second composite material 5. As in the example according to FIG. 1, the second composite material 5 consists of a polymeric binder matrix 10, in turn a polyester-resin matrix, a filler in the form of a flame retardant 11, in turn aluminum trihydrate, and also pigments 12, in turn for example TiO₂, being introduced in the binder matrix 10. The outer coating 5 thus corresponds to that of FIG. 1.

However, the structure or the composition of the first composite material 4 is different. This consists in turn of a polymeric binder matrix 6, in which in turn hollow glass beads 7 are introduced in a corresponding fraction. Likewise optionally included are color pigments 9, also here in turn TiO₂.

In the first composite material 4, which is shown here, however, the relatively expensive flame retardant ATH is replaced by a metal carbonate 13 in the form of calcium carbonate, in the present case a complete replacement being assumed. It would also be conceivable to replace ATH only partially. That is to say that, in the simplest configuration, the first composite material only consists of the binder matrix 6 and the hollow glass beads 7 and also the metal carbonate 13, but contains neither color pigments 9 nor further additives, in particular in the form of the flame retardant 8.

As can be seen in both FIGS. 1 and 2, by virtue of a mechanical surface treatment of the two outer surfaces of the support body 2, hollow glass beads 7 which are close to the surface have been opened, that is to say ground open. This leads to a microporosity on the support body 2, which could lead in turn to the carrier body 2 tending to be easier to contaminate if it is not sealed by way of the outer coatings 5 provided according to the invention, since very fine dirt particles can penetrate into the micropores, i.e. the open hollow glass bodies 7.

As a consequence of the outer coatings 5 on the processed surfaces that are applied according to the invention, however, a complete sealing takes place with an outer coating which is comparable to the fundamental haptics, since said outer coating also consists of a binder matrix which contains fillers, etc.

FIGS. 1 and 2 are merely examples of a possible composition of the first and second composite materials 4, 5. It is fundamentally possible that the composite materials 4, 5 shown contain additional fillers such as, for example, quartz, dolomite, zircon, muscovite, garnet, melanite or feldspar. In particular, the first composite material 4 contains these fillers, since said first composite material ultimately does not necessarily need to have the corresponding visual and haptic properties as required by the outer coating 5, because said first composite material is sealed by the outer coating 5 which in turn forms the exterior visible surface. It is therefore readily possible, for example, to replace the color pigments 5 with another, cheap filler such as quartz or dolomite, since the support body 2 does not have to be colored throughout, since the outer coating 5 is colored. It may also be the case that the flame retardant is also replaced to a corresponding extent, or else, as described, completely, by adding one or more of the abovementioned additional fillers.

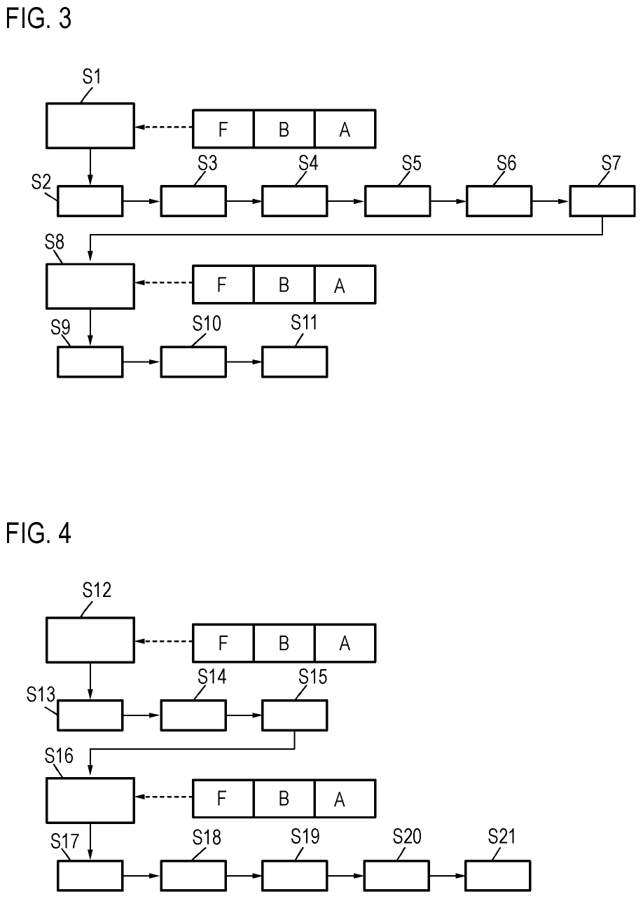

In the form of a flow diagram, FIG. 3 shows a first method variant according to the invention for producing a sanitary article according to the invention.

The casting composition, which forms the first composite material, is prepared in step S1. For this purpose, the binder B, i.e. the polyester resin, the additives A, such as for example the hardening agent (MEKP) and also color pigments, and the filler F, in the present case calcium carbonate since by way of example the configuration according to FIG. 2 is described, are mixed with one another in order to form the corresponding, sufficiently castable mass. Hollow glass beads are used as filler F.

The mass is cast into the mold in step S2, where it gelates and hardens in step S3. 2 0 This takes place at approx. 35°-40° Celsius for a duration of 15-40 minutes. After the hardening, the then-cast, finished support body is removed from the mold in step S4. It consists of the first composite material, which contains hollow glass beads.

In step S5, said first composite material is thermally treated, i.e. tempered, at a temperature of 60°-120° for 2-6 hours in order to reduce any stresses. Subsequent to this, in step S6, a mechanical reworking by grinding the surface takes place, it being possible for the hollow glass beads close to the surface to be ground open, i.e. opened, in the process, as described.

Then, in step S7, the finished support body is prepared for the subsequent coating with the outer coating.

This is prepared in step S8. In turn, for this purpose, the binder B, the polyester resin, the additives A such as the hardening agent and here imperatively the color pigments, and the filler F, in the present case the flame retardant aluminum trihydrate, are mixed in order to form a fluid, sprayable mass. Compared with the mass produced in step S1, the binder fraction of the mass produced in step S8 is considerably higher, in order to adjust the sprayability. This mass does not contain any hollow glass beads.

In step S9, the fluid mass produced in step S8 is sprayed onto the ground surfaces of the support body, the layer thickness being between 0.1-2 mm in relation to the finished, hardened state.

After the spraying-on, in step S10, for the purpose of hardening it is also the case here that a temperature-controlling step takes place at 60°-110° Celsius for 2-3 hours, that is to say that it is also the case here that any layer stresses are reduced by tempering. This forms the second composite material, which does not contain any hollow glass beads.

In step S11, which is however optional, the sprayed-on coating surface is reworked in order to provide it with a matt finish. This matt finish is provided by a very fine grinding means, there being no problems in this respect in terms of grinding open the hollow glass beads as there are when the support body is being mechanically ground, since the outer coating 5 does not contain any hollow glass beads.

In the method variant according to FIG. 3, the support body is thus produced as a separate component in a corresponding casting mold, which is subsequently covered with the outer coating. FIG. 4 describes an alternative method variant, in which the two layers or parts are applied or created in a common mold.

According to FIG. 4, in step S12, first the fluid mass which serves for forming the outer coating 5 is produced. For this purpose, in turn, the binder B, polyester resin, and the additives A, such as hardening agents and color pigments, and also the filler F in the form of the flame retardant are correspondingly mixed in order to form a sprayable mass.

In step S13, said sprayable mass is then sprayed onto the mold surfaces of the casting mold in which the actual support body is subsequently cast, specifically with a corresponding low layer thickness, in order to form the thin outer coating 5 on the end product.

In step S14, the sprayed-out mass is tempered at 60-110° for 0.5-3 hours such that it at least sets; a complete through-hardening is not absolutely necessary.

In step S15, the casting mold is prepared for the subsequent step in that, as described below, the outer coating is backfilled with the first composite material, which forms the support body.

The fluid mass, which forms the first composite material, is produced in step S16. For this purpose, in turn, the binder B, polyester resin, the additives A, such as hardening agents and color pigments, and also here again the metal carbonate, specifically calcium carbonate, as filler F are mixed in order to form a castable mass, which is then cast into the casting mold in step S17. In this respect, a complete backfilling of the set outer coating of the second composite material occurs.

The casting is followed, in step S18, by the gelating or hardening operation, which takes place at 35°-40° Celsius for 15-40 minutes. In that case, after both masses are hardened, i.e. both the support body 2 and the outer coating 5, the then almost-finished sanitary article is removed from the mold in step S19 and tempered at 60°-110° Celsius for 2-6 hours in step S20 in order to reduce any stresses in the sanitary article. The sanitary article is thus ultimately finished; this is followed merely still by an optional mechanical surface treatment in step S21 when the intention is to provide the surface with a matt finish.

Whereas in the example described above it is always the case that only calcium carbonate was used as filler for forming the first composite material composition of the support body, there is instead also the possibility of using ATH, i.e. the flame retardant, that is to say that ultimately the structure of the first and second composite materials are relatively similar in terms of the constituent parts. In addition, there is however of course also the possibility that also in this case further fillers, such as quartz, dolomite and the like, are added.

While specific embodiments of the invention have been shown and described in detail to illustrate the inventive principles, it will be understood that the invention may be embodied otherwise without departing from such principles.

I claim:

1. A sanitary article, which has a support body and an outer coating which is applied to said support body at least in certain portions and forms the outer side of the sanitary article, the support body consisting of a first composite material of a filled polymeric binder matrix containing at least one filler in the form of hollow glass beads and the outer coating consisting of a second composite material of a polymeric binder matrix, which is filled with at least one filler and does not contain any hollow glass beads.

2. The sanitary article according to claim 1, wherein the constituent parts of the first composite material and the constituent parts of the second composite material are the same except for the hollow glass beads, or in that the constituent parts of the first composite material and the constituent parts of the second composite material differ at least to some extent besides the hollow glass beads.

3. The sanitary article according to claim 1, wherein the second composite material contains at least one flame retardant, in particular aluminum trihydrate, as filler.

4. The sanitary article according to claim 1, wherein the second composite material contains at least one color additive, in particular an organic pigment or an inorganic pigment.

5. The sanitary article according to claim 4, wherein the inorganic pigment is titanium dioxide.

6. The sanitary article according to claim 1, wherein the second composite material contains (in % by weight of the hardened composite material):
Polymeric binder: 44.0-65.0
Flame retardant: 35.0-55.0
Color additive: 1.0-5.0

7. The sanitary article according to claim 1, wherein the first composite material contains (in % by weight of the hardened composite material):
Polymeric binder: 34.0-49.0
Flame retardant+poss. quartz: 47.0-62.0
Hollow glass beads: 1.0-5.1
Color additive: 2.4-2.8

8. The sanitary article according to claim 1, wherein the first composite material also contains a metal carbonate, in particular calcium carbonate, as filler.

9. The sanitary article according to claim 1, wherein the first composite material contains (in % by weight of the hardened composite material):
Polymeric binder: 19.0-50.0
Metal carbonate: 45.0-70.0
Hollow glass beads: 0.5-9.5

10. The sanitary article according to claim 8, wherein the first composite material contains as filler at least one flame retardant, in particular aluminum trihydrate, to a maximum of 21% by weight.

11. The sanitary article according to claim 8, wherein the first composite material contains at least one color additive, in particular an organic pigment or an inorganic pigment, to a maximum of 5.0% by weight.

12. The sanitary article according to claim 11, wherein the inorganic pigment is titanium dioxide.

13. The sanitary article according to claim 1, wherein the first and/or second composite material also contains quartz as filler, the first composite material containing quartz to a maximum of 10.1% by weight and the second composite material containing quartz to a maximum of 5.7% by weight.

14. The sanitary article according to claim 1, wherein the first and/or the second composite material also contains dolomite as filler, the first and the second composite material each containing dolomite to a maximum of 7.3% by weight.

15. The sanitary article according to claim 1, wherein the first and/or the second composite material also contains one or more fillers selected from zircon, muscovite, garnet, melanite and feldspar, each to a maximum of 3.8% by weight.

16. The sanitary article according to claim 1, wherein the thickness of the outer coating is between 0.1-2.0 mm, in particular between 0.2-1.5 mm.

17. The sanitary article according to claim 1, wherein the overall thickness of the support body and outer coating is between 8.0-26.0 mm.

18. The sanitary article according to claim 1, wherein the article is a bathtub, a shower base, a shower tray, a wash basin, a washstand or a WC.

19. A method for producing a sanitary article according to claim 1, wherein a fluid outer coating of a polymeric binder, which is filled with at least one filler but does not contain any hollow glass beads, is applied at least in certain portions to a support body of a first composite material of a filled polymeric binder matrix containing at least one filler in the form of hollow glass beads, said polymeric binder then hardening to form a second composite material.

20. The method according to claim 19, having the following steps:
casting a polymeric casting composition of a filled polymeric binder containing at least one filler in the form of hollow glass beads into a mold and hardening the casting composition to form the support body,
thermally and/or mechanically aftertreating the support body which has been removed from the mold,
applying a further polymeric, fluid mass of a polymeric binder, which is filled with at least one filler but does not contain any hollow glass beads, in order to form the outer coating,
performing thermal aftertreatment in order to harden the outer coating and possibly mechanically aftertreating the outer coating.

21. The method according to claim 19, wherein the fluid mass is sprayed out or applied by dipping.

22. The method according to claim 19, wherein a fluid mass of a polymeric binder, which is filled with at least one filler but does not contain any hollow glass beads, is introduced into a mold for the purpose of coating the mold surfaces, which mass at least sets to form an outer coating, after which a further polymeric casting composition, which contains a filler in the form of hollow glass beads, is introduced into the mold such that the outer coating is backfilled, after which the mass and the casting composition harden to form two composite materials.

23. The method according to claim 22, having the following steps:
spraying the fluid mass of a polymeric binder, which is filled with at least one filler but does not contain any hollow glass beads, onto the mold surfaces,
thermally treating the coating in such a way that the coating sets to form an outer coating,
casting the further polymeric casting composition, which contains a filler in the form of hollow glass beads, into the mold such that the outer coating is backfilled,
hardening the mass and the casting composition,
thermally aftertreating the sanitary article and possibly mechanically aftertreating the outer coating.
